(19) United States
(12) Patent Application Publication
(10) Pub. No.: US 2010/0217944 A1
(43) Pub. Date: Aug. 26, 2010

(54) SYSTEMS AND METHODS FOR MANAGING CONFIGURATIONS OF STORAGE DEVICES IN A SOFTWARE PROVISIONING ENVIRONMENT

(76) Inventors: Michael Paul DeHaan, Morrisville, NC (US); Adrian Karstan Likins, Raleigh, NC (US); Seth Kelby Vidal, Raleigh, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 12/393,613

(22) Filed: Feb. 26, 2009

(51) Int. Cl. G06F 12/00; G06F 15/173; G06F 1/26; G06F 12/16

(52) U.S. Cl. 711/156; 709/223; 713/300; 711/161; 711/E12.001; 711/E12.103

(57) ABSTRACT

A provisioning server can provide and interact with a storage device tool on target machines. The storage device tool can communicate with the storage devices of the target machines, independent of the types of the storage devices. To communicate independent of the type of the storage device, the storage device tool can include a translation library. The translation library enables the storage device tool to receive common commands and/or instructions for interacting with the storage devices and convert those common commands and/or instructions into specific commands and/or instructions that are compatible with different types of the storage devices.

### FIELD

This invention relates generally to software provisioning. In particular, the invention relates to systems and methods for managing storage devices in a software provisioning environment.

### DESCRIPTION OF THE RELATED ART

Software provisioning is the process of selecting a target machine, such as a server, loading the appropriate software (operating system, device drivers, middleware, and applications), and customizing and configuaring the system and the software to make it ready for operation. Software provisioning can entail a variety of tasks, such as creating or changing a boot image, specifying parameters, e.g. IP address, IP gateway, to find associated network and storage resources, and then starting the machine and its newly-loaded software. Typically, a system administrator will perform these tasks using various tools because of the complexity of these tasks. Unfortunately, there is a lack of provisioning control tools that can adequately integrate and automate these tasks.

Often, large entities, such as corporations, businesses, and universities, maintain large networks that include numerous systems spread over a wide geographic area. Often, these systems include a variety of hardware and hardware configurations. For example, these systems may include several external and internal storage devices, such as hard disk drives, optical storage devices, and the like. Typically, each vendor of a particular storage device provides various tools to manage the storage device they manufacture and these tools are often not cross-compatible between different vendors. To manage the different storage devices, the administrator of the network must utilize each vendor's tools separately in order to configure and manage the different storage devices.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates an overall provisioning environment in which various embodiments of the present teachings can be practiced;

FIG. 2 illustrates the overall provisioning environment in which a provisioning server can manage storage devices of target machines, according to various embodiments;

FIG. 3 illustrates an exemplary hardware configuration for a provisioning server, according to various embodiments; and

FIG. 4 illustrates a flowchart for managing storage devices of target machines, according to various embodiments.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of information and systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments of the present teachings relate to systems and methods for managing storage devices of target machines in a software provisioning environment. More particularly, a provisioning server can utilize a storage device tool on target machines in order to manage and configure storage devices associated with the target machines, regardless of a type and origin of the storage device.

According to embodiments, a provisioning server can be configured to provide and to interact with a storage device tool on target machines. The storage device tool can be configured to operate on the target machines and communicate with storage devices associated with the target machines, independent of the type of the storage devices. The storage device tool can be configured to communicate with the storage devices and manage the storage devices under the direction of the provisioning server.

According to embodiments, to communicate independent of the type of storage device, the storage device tool can be configured to include a translation library. The translation library enables the storage device tool to receive common commands for interacting with a storage device and convert those common commands into specific commands that are compatible with different types of storage devices. As such, the storage device tool can be configured to communicate with any type of storage device regardless of the type of storage device.

According to embodiments, to provide the storage device tool, the provisioning server can be configured to instruct a network management server to provide a command to a helper client on the target machines. The command can be configured to cause the helper client to retrieve the storage device tool from the provisioning server. Additionally, the provisioning server can be configured to instruct the helper client, directly. Likewise, the provisioning server can be configured to transmit the storage device tool to the target machines and to instruct the target machines to alter their power state (e.g. power cycle), if necessary, to initiate the storage device tool.

According to embodiments, the provisioning server can be configured to interact with the storage device tool, directly, to instruct the storage device tool. Likewise, the provisioning server can be configured to operate in conjunction with the network management server in order to instruct the storage device tool.

According to embodiments, the storage device tool can be configured to perform various management processes on the storage devices. The storage device tool can be configured to receive commands from the provisioning server, to convert the commands into commands compatible with a particular storage device, and to utilize the converted commands to manage and configure a storage device. Additionally, the storage device tool can be configured to collect configuration data for the storage device and to provide the configuration data to the provisioning server. Once data is received, the provisioning server can be configured to store the collected data in storage device records.

According to embodiments, the provisioning sever can be configured to maintain the storage device records in order to track and manage the storage devices of the target machines in the software provisioning environment. For example, the provisioning server can be configured to utilize the collected data in the storage device records and the storage device tool to restore a storage device in the event of a failure of the target machine.

By providing a storage device tool from a provisioning server, the provisioning server can manage the storage devices of the target machines in the software provisioning environment. Additionally, because the storage device tool is universally compatible with different types of storage devices, the provisioning server can manage the configuration of a wide variety of storage devices without utilizing separate tools and protocols for each different type of storage device.

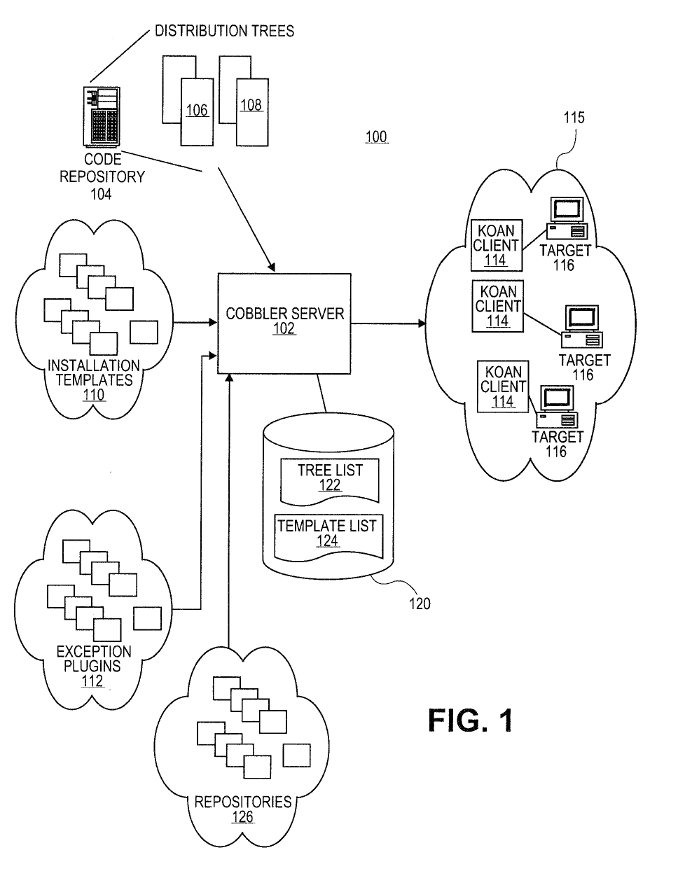

FIG. 1 illustrates an overall provisioning environment 100, in systems and methods for the execution, management, and monitoring of software provisioning, according to exemplary aspects of the present disclosure. Embodiments described herein can be implemented in or supported by the exemplary environment illustrated in FIG. 1. The provisioning environment 100 provides a unified provisioning environment, which comprehensively manages the tasks related to software provisioning.

In particular, the provisioning environment 100 can manage software provisioning using a hierarchy of commands. In exemplary embodiments, the hierarchy can include at least four levels of commands. The lowest level in the hierarchy can comprise distribution commands, which primarily handle base operating system specific tasks of provisioning. The second level can comprise profile commands, which associate a configuration file, such as a kickstart file for Linux or other operating system, with a distribution and optionally allow for customization. The third level comprises system commands, which associate remote systems that are involved with the provisioning of the software. The fourth level comprises repository commands, which address configurations and tasks related to updating the software, remote installation procedures, and optionally customizing the software.

The provisioning environment 100 provides several capabilities and advantages over the known provisioning solutions. For example, the present invention is capable of handling a variety of forms of installations, such as preboot execution environment (“PXE”), virtualization, re-installations, and image installations.

In exemplary aspects, the provisioning environment 100 enables integrating virtualization into a PXE provisioning infrastructure and provides several options to reinstall running machines as well. The provisioning environment 100 can integrate mirroring of package repositories with the provisioning process, so that a provisioning server may serve as a central mirror point of contact for all of an organization's software needs. In aspects, a set of remote mirrored repositories can automatically be used by provisioned systems without additional setup.

Reference will now be made in detail to the exemplary aspects the provisioning environment 100. The provisioning environment 100 can be applied to provisioning any form of software, such as Windows systems, UNIX systems, and Linux systems. In the exemplary description that follows, FIG. 1 is presented to explain the provisioning environment 100 for provisioning software, such as Linux, and Linux based software, such as Fedora and Red Hat Enterprise Linux by Red Hat, Inc.

In provisioning of software such as Linux, many system administrators use what is known as the “kickstart” installation method. Kickstart files are files that specify the intended configuration of the software being provisioned. Kickstart files can be kept on a server and can be read by individual computers during the installation. This installation method allows the use of a single or relatively few standard kickstart files to install Linux on multiple machines, making it ideal for network and system administrators.

The kickstart file can be a simple text file, containing a list of items, each identified by a keyword. In general, a kickstart file can be edited with any text editor or word processor that can save files as ASCII text. One skilled in the art will recognize that the present invention may be applied to non-kickstart files in software provisioning. For example, configuration files such as AutoYAST Answer files used in Novell SuSe Linux and Sun Solaris Jumpstart files may also be used by the provisioning environment 100.

Typically, a kickstart file can be copied to the boot disk, or made available on the network. The network-based approach is most commonly used, as most kickstart installations for software provisioning, such as Linux systems, tend to be performed via a network using NFS, FTP, or HTTP on networked computers. Administrators also find it desirable that kickstart installations can be performed using a local CD-ROM, or a local hard drive.

Using kickstart files, a system administrator can create a single file containing the parameters that are needed to complete a typical software installation. For example, kickstart files specify parameters related to: language selection; mouse configuration; keyboard selection; boot loader installation; disk partitioning; network configuration; NIS, LDAP, Kerberos, Hesiod, and Samba authentication; firewall configuration; and package selection.

According to exemplary aspects illustrated in FIG. 1, the provisioning environment 100 can include a provisioning server 102, a code repository 104 which provides access to distributions 106 and 108, a set of installation templates 110, a set of exception plugins 112, a helper client 114 running on target machines 116 in a network 115, a provisioning database 120 which comprises a distribution tree list 122 and template list 124. Each of these components will now be further described.

The provisioning server (from herein referred to as a “cobbler”) 102 is responsible for: serving as an extensible markup language remote procedure call (XMLRPC) handler; liking to or mirroring install distribution trees and a configuration database; hosting kickstart templates; hosting plugins; generating installation images, and the like. The cobbler server 102 can be implemented as software, such as Python code, installed on a boot server machine and provide a command line interface for configuration of the boot server. In addition, the cobbler server 102 can make itself available as a Python application programming interface (API) for use by higher level management software (not shown). The cobbler server 102 supports provisioning via PXE, image (ISO) installation, virtualization, re-provisioning. As will be described later, the last two modes are performed with the assistance of a helper client 114.

The code repository 104 is responsible for hosting distributions 106 and 108. The code repository 104 can be implemented using well known components of hardware and software. Additionally, the code repository 104 can include one or more repositories hosting distributions. The distributions 106 and 108 can include bundles of software that are already compiled and configured. The distributions 106 and 108 may be in the form of either rpm, deb, tgz, msi, exe formats, and the like. For example, as Linux distributions, the distributions 106 and 108 are bundles of software that comprise the Linux kernel, the non-kernel parts of the operating system, and assorted other software. The distributions 106 and 108 can take a variety of forms, from fully-featured desktop and server operating systems to minimal environments.

In exemplary aspects, the installation templates 110 are any data structure or processing element that can be combined with a set of installation configurations and processed to produce a resulting configuration file, such as a kickstart file.

In exemplary aspects, exception plugins 112 are software that interact with cobbler server 102 to customize the provisioning of software. In general, the exception plugins 112 are intended to address infrequent customization needs.

In exemplary aspects, the helper client (known as “koan”, which stands for “kickstart-over-a-network”) 114 can assist the cobbler server 102 during the provisioning processes. The koan 114 can allow for both network provisioning of new virtualized guests and destructive provisioning of any existing system. When invoked, the koan 114 can request profile information from a remote boot server that has been configured with the cobbler server 102. In some aspects, what the koan 114 does with the profile data depends on whether it was invoked with --virt or -replace-self.

In exemplary aspects, the koan 114 can enable replacing running systems as well as installing virtualized profiles. The koan 114 can also be pushed out to systems automatically from the boot server. In some aspects, the koan client 114 is also written in Python code to accommodate a variety of operating systems, machine architectures, etc.

In exemplary aspects, the network 115 can include a number of the target machines 116. The target machines 116 can represent the particular machines to which software provisioning is directed. The target machines 116 can represent a wide variety of computing devices, such as personal computers, servers, laptop computers, personal mobile devices, and the like. In some aspects, the target machines 116 can represent distributed computing environments such as cloud computing environments. Although FIG. 1 shows several of the target machines 116, the provisioning environment 100 can be capable of managing a wide range environments, such as datacenters with thousands of machines or server pools with just a few machines. Additionally, the cobbler server 102 can be connected to multiple networks 115.

In exemplary aspects, the provisioning database 120 can serve as a data storage location for holding data used by the cobbler server 102. For example, as shown, the provisioning database 120 can comprise the distribution tree list 122 and the template list 124. The distribution tree list 122 can provide an inventory of the distributions 106 and 108 that are hosted or mirrored by the cobbler server 102. The template list 124 can provide an inventory of the templates 110 that are hosted by the cobbler server 102.

As noted above, the cobbler server 102 can manage provisioning using a hierarchical concept of distribution commands, profile commands, system commands, and repository commands. This framework enables the cobbler server 102 to abstract the differences between multiple provisioning types (installation, reinstallation, and virtualization) and allows installation of all three from a common platform. This hierarchy of commands also permits the cobbler server 102 to integrate software repositories 126 with the provisioning process, thus allowing systems to be configured as a mirror for software updates and third party content as well as distribution content.

Distributions can contain information about base operating system tasks, such as what kernel and initial ramdisk (“initrd”) are used in the provisioning, along with other information, such as required kernel parameters. Profiles associate one of the distributions 106 and 108 with a kickstart file and optionally customize it further, for example, using plugins 112. System commands associate a hostname, IP, or (machine access control) MAC with a distribution and optionally customize the profile further. Repositories contain update information, such as yum mirror information that the cobbler server 102 uses to mirror repository 104. The cobbler server 102 can also manage (generate) dynamic host configuration protocol (DHCP) configuration files using the templates 110.

In exemplary aspects, the cobbler server 102 can use a provisioning environment that is fully templated, allowing for kickstarts and PXE files to be customized by the user. The cobbler server 102 uses the concept of “profiles” as an intermediate step between the operating system and the installed system. A profile is a description of what a system does rather than the software to be installed. For instance, a profile might describe a virtual web server with X amount of RAM, Y amounts of disk space, running a Linux distribution Z, and with an answer file W.

In exemplary aspects, the cobbler server 102 can provide a command line interface to configure a boot server in which it is installed. For example, the format of the cobbler server 102 commands can be generally in the format of: cobbler command [subcommand] [--arg1] [--arg2=]. Thus, a user can specify various aspects of software provisioning via a single interface, such as a command line interface or other known interface. Examples of exemplary cobbler commands can be found in U.S. patent application Ser. No. 11/763,315, U.S. Patent Application Publication No. 2008-0288938 and U.S. patent application Ser. No. 11/763,333, U.S. Patent Publication No. 2008-0288939, all assigned to Red Hat Corporation, the disclosures of which are incorporated herein, in their entirety, by reference.

According to exemplary aspects, a user can use various commands of the provisioning environment 100 to specify distributions and install trees hosted by the code repository 104, such as a distribution from the distributions 106 or 108. A user can add or import a distribution or import it from installation media or an external network location.

According to exemplary aspects, in order to import a distribution, the cobbler server 102 can auto-add distributions and profiles from remote sources, whether this is an installation media (such as a DVD), an NFS path, or an rsync mirror. When importing an rsync mirror, the cobbler server 102 can try to detect the distribution type and automatically assign kickstarts. By default in some embodiments, the cobbler server can provision by erasing the hard drive, setting up eth0 for DHCP, and using a default password. If this is undesirable, an administrator may edit the kickstart files in /etc/cobbler to do something else or change the kickstart setting after the cobbler server 102 creates the profile.

According to exemplary aspects, a user may map profiles to the distributions and map systems to the profiles using profile commands and systems commands of the provisioning environment 100. A profile associates a distribution to additional specialized options, such as a kickstart automation file. In the cobbler server 102, profiles are the unit of provisioning and at least one profile exists for every distribution to be provisioned. A profile might represent, for instance, a web server or desktop configuration.

According to exemplary aspects, a user can map systems to profiles using system commands. System commands can assign a piece of hardware with cobbler server 102 to a profile. Systems can be defined by hostname, Internet Protocol (IP) address, or machine access control (MAC) address. When available, use of the MAC address to assign systems can be preferred.

According to exemplary aspects, the user can map repositories and profiles using repository commands. Repository commands can address configurations and tasks related to updating the software, remote installation procedures, and optionally customizing the software. These repository commands can also specify mirroring of the provisioned software to remote servers. Repository mirroring can allow the cobbler server 102 to mirror not only the trees 106 and 108, but also optional packages, third party content, and updates. Mirroring can be useful for faster, more up-to-date installations and faster updates, or providing software on restricted networks. The cobbler server 102 can also include other administrative features, such as allowing the user to view their provisioning configuration or information tracking the status of a requested software installation.

According to exemplary aspects, a user can utilize commands to create a provisioning infrastructure from a distribution mirror. Then a default PXE configuration is created, so that by default, systems will PXE boot into a fully automated install process for that distribution. The distribution mirror can be a network rsync mirror or a mounted DVD location.

According to exemplary aspects, the administrator uses a local kernel and initrd file (already downloaded), and shows how profiles would be created using two different kickstarts—one for a web server configuration and one for a database server. Then, a machine can be assigned to each profile.

According to exemplary aspects, a repo mirror can be set up for two repositories, and create a profile that will auto install those repository configurations on provisioned systems using that profile.

According to exemplary aspects, in addition to normal provisioning, the cobbler server 102 can support yet another option, called “enchant”. Enchant takes a configuration that has already been defined and applies it to a remote system that might not have the remote helper program installed. Users can use this command to replace a server that is being repurposed, or when no PXE environment can be created. Thus, the enchant option allows the remote the koan client 114 to be executed remotely from the cobbler server 102.

According to aspects, if the cobbler server 102 is configured to mirror certain repositories, the cobbler server 102 can then be used to associate profiles with those repositories. Systems installed under those profiles can be auto configured to use these repository mirrors in commands and, if supported, these repositories can be leveraged. This can be useful for a large install base, when fast installation and upgrades for systems are desired, or software not in a standard repository exists and provisioned systems desire to know about that repository.

According to exemplary aspects, the cobbler server 102 can also keep track of the status of kickstarting machines. For example, the “cobbler status” will show when the cobbler server 102 thinks a machine started kickstarting and when it last requested a file. This can be a desirable way to track machines that may have gone inactive during kickstarts. The cobbler server 102 can also make a special request in the post section of the kickstart to signal when a machine is finished kickstarting.

According to exemplary aspects, for certain commands, the cobbler server 102 will create new virtualized guests on a machine in accordance with orders from the cobbler server 102. Once finished, an administrator can use additional commands on the guest or other operations. The cobbler server 102 can automatically name domains based on their MAC addresses. For re-kickstarting, the cobbler server 102 can reprovision the system, deleting any current data and replacing it with the results of a network install.

According to exemplary aspects, the cobbler server 102 can configure boot methods for the provisioning requested by the user. For example, the cobbler server 102 can configure a PXE environment, such as a network card BIOS. Alternatively, the cobbler server 102 can compile and configure information for koan client 104. The cobbler server 102 can also optionally configure DHCP and DNS configuration information.

According to exemplary aspects, the cobbler server 102 can serve the request of the koan client 114. The koan client 114 can acknowledge the service of information of the cobbler server 102 and can then initiate installation of the software being provisioned. Additionally, the koan client 114 can either install the requested software, e.g., replace the existing operating system, or install a virtual machine.

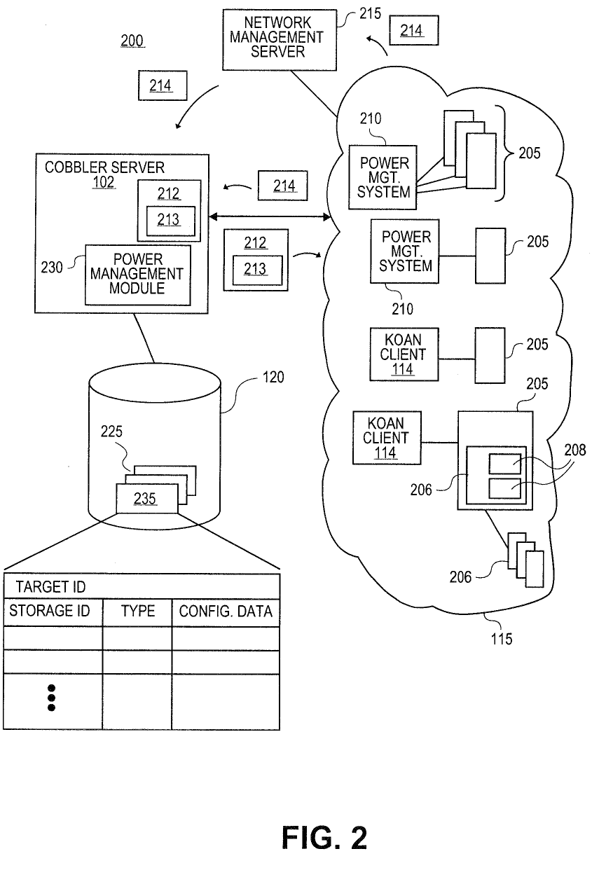

FIG. 2 illustrates aspects of the provisioning environment 200 that allows management of storage devices of target machines, remotely. In embodiments as shown, the cobbler server 102 can be coupled to a network 115 and a network management server 215 to provide provisioning processes and other actions related to provisioning for the network 115. While FIG. 2 illustrates one network 115 with exemplary components, one skilled in the art will realize that the cobbler server 102 can be coupled to multiple networks to provide provisioning processes and other actions related to provisioning.

As shown in FIG. 2, the network 115 can include a number of target machines 205. For example, the target machines 205 can include a group of server computers, such as blade servers. The target machines 205 can include computing systems such as servers, personal computers, laptop computers, etc. The target machines 205 can be connected to power management systems 210 to control the power supplied to the target machines 205 and to alter the power state of one or more of the target machines 205 (e.g. power cycle). The power management systems 210 can be any type of system to manage the power of the target machines, for example, Integrated Lights Out (ILO) by Hewlett Packard™ Corporation, Dell™ Remote Access Control (DRAC) by Dell Corporation, WTI powerbar by Western Telematics, Inc, and other power system supporting network communications. Additionally, each of the target machines 205 can be configured to include a koan client 114.

In embodiments, the target machines 205 can include hardware typically found in conventional computing system (processors, memory, video cards, network interface cards, storage devices, and the like). For the storage devices, the target machines 205 can include multiple types of storage devices. For example, the target machines 205 can include internal and external physical storage devices 206 (hard disk drives, optical drives, etc.) and virtual storage devices 208 (one or more virtual drives in a physical storage device). The different storage devices also interface with the target system 205 utilizing both open source standards and proprietary interfaces, such as Small Computer System Interface (SCSI), Serial ATA (SATA), Serial Attached SCSI (SAS), and the like, and arrange data according to a variety of systems such as Redundant Array of Independent Disks (RAID). Likewise, the vendors that manufacture particular physical storage devices utilize different commands, tools, APIs, or protocols for configuring and managing the storage devices and different formats for the configuration data of the storage devices. The storage device configuration data can include an identification of the storage device, an identification of the type and origin of the storage device, information for initializing the storage device, information describing the type of interface of the storage device, information specifying how information is stored on the storage device, and the like.

In embodiments, the cobbler server 102 can be configured to manage the storage devices 206 and 208 of the target machines 205, regardless of the type of the storage devices 206 and 208 and the vendor which manufactured the storage devices 206 and 208. To achieve this, the cobbler server 102 can be configured to provide a storage device tool 212 to one or more of the target machines 205 and to interact with the storage device tool 212 in order to collect storage device configuration data 214 from the storage devices 206 and 208 and to manage the storage devices 206 and 208.

In embodiments, the storage device tool 212 can be configured to execute on the target machines 205 and to communicate with the storage devices 206 and 208 independent of the type, origin, and configuration of the storage devices 206 and 208. To achieve this, the storage device tool 212 can be configured to include a translation library 213. The translation library 213 can include lists of the specific commands and/or instructions to communicate with the different storage devices and a conversion table to convert common commands and/or instructions to the specific commands and/or instructions for communicating with the different storage devices. The conversion table maps a particular common command and/or instruction to a particular command and/or instruction in the particular list of specific commands and/or instructions of a particular storage device. By knowing the type of storage device, the translation library 235 enables the storage device tool 212 to receive the common commands and/or instructions for interacting with a storage device and convert those common commands and/or instructions into the specific commands and/or instructions that are compatible with the storage device.

In embodiments, additionally, the translation library 235 can include lists of the formats for the configuration data of the different storage devices and a conversion table for converting the different configuration data formats into a common configuration data format. As such, the storage device tool 212 can be configured to communicate with any storage device regardless of the type, configuration, and origin of the storage device.

In embodiment, the storage device tool 212 can also be configured to include the necessary logic, routines, instruction, and commands to boot the target machines 205 or communicate with the OS of the target machines 205 in order to identify the type of the storage devices 206 and 208, and to communicate with the storage devices 206 and 208 of the target machines 205 in order to manage and configure the storage devices 206 and 208. The storage device tool 212 can be, for example, a disk image, an ISO image, a software appliance (e.g. portions of an OS and applications), or any other type of tailored software application capable of executing on the target machines 205, separately, or in cooperation with the OS.

In embodiments, the cobbler server 102 can be configured to utilize the storage device tool 212 to perform any number of management processes on the storage device of the target machines 205. The cobbler server 102 can be configured to utilize the storage device tool 212 to collect storage device configuration data 214, alter the storage device configuration data, repair the storage device configuration data, and the like.

In embodiments, the cobbler server 102 can initiate providing the storage device tool 212 upon the occurrence of any number of events. For example, the cobbler server 102 can provide the storage device tool 212 when a target machine 205 is added to the network 115 or new storage devices 206 or 208 are added to a target machine 205. Likewise, the cobbler server 102 can provide the storage device tool 212 to the target machines 205 to configure or re-configure the storage devices 206 and 208 of the target machines 205. Additionally, the cobbler server 102 can be configured to provide the storage device tool 212 in the event an error occurs on the storage devices 206 or 208 of the target machines 205 (hardware/software failure, intruder attack on the target machines 205, etc.).

In embodiments, the cobbler server 102 can be configured to maintain the storage device tool 212 for access and utilization in managing the storage devices 206 and 208 of the target machines 205. For example, the cobbler server 102 can be configured maintain the storage device tool 212 in a storage device or system (CD, DVD, hard drive, portable storage memory, database etc.) whether local to the cobbler server 102 or remotely located. Additionally, the cobbler server 102 can maintain the storage device tool 212 or information specifying the location of the storage device tool 212 in the provisioning database 120.

In embodiments, to provide the storage device tool 212, the cobbler server 102 can be configured to provide the storage device tool 212 utilizing the network management server 215. The cobbler server 102 can be configured to instruct the network management server 215 to provide a command to the koan client 114 on the target machines 205. The command can be configured to cause the koan client 114 to retrieve the storage device tool 212 from the cobbler server 102 and initiate the storage device tool 212 on the target machines 205. Likewise, the cobbler server 102 can be configured to directly instruct the koan client 114 to retrieve the storage device tool 212 and to initiate the storage device tool 212.

In embodiments, the network management server 215 can be any type of network management application or tool to securely communicate with the target machines 205, to monitor the state of the target machines 205, to retrieve and request data from the target machines 205, and to manage and direct the target machines 205. For example, the network management server 215 can be a “FUNC” server as described in U.S. patent application Ser. No. 12/130,424, filed May 30, 2008, entitled “SYSTEMS AND METHODS FOR REMOTE MANAGEMENT OF NETWORKED SYSTEMS USING SECURE MODULAR PLATFORM” (U.S. Patent Application Publication No. ______) assigned to Red Hat Corporation, the disclosure of which is incorporated herein, in its entirety, by reference.

In embodiments, additionally, the cobbler server 102 can be configured to provide the storage device tool 212 to the target machines 205, directly. To achieve this, the cobbler server 102 can be configured to transmit the storage device tool 212 to the target machines 205.

In embodiments, once the storage device tool 212 is transmitted, the cobbler server 102 can be configured to instruct the target machines 205 to alter their power state (e.g. power cycle) to initiate the storage device tool 212, if necessary. For example, in order to communicate with the storage device, the target machines 205 may need to be power cycled. The cobbler server 102 can power cycle (power down/power up) the target machines 205 in order to initiate the storage device tool 212 or restart the target machines 205 after the storage device tool 212 has completed management. The cobbler server 102 can be configured to communicate with the power management system 210 of the target machines 205 to alter the power state of the target machines 205. To achieve this, the cobbler server 102 can be configured to include a power management module 230.

In embodiments, the power management module 230 can be configured to communicate with the power management systems 210 of the target machines 205. The power management module 230 can be configured to instruct the power management systems 210 to alter the power state of the target machines 205. The power management module 230 can be configured to generate a command or instruction. The instruction can include access information for the power management systems 210 and the power state alteration to be performed.

In embodiments, the power management module 230 can be configured to form the instruction in a protocol utilized by the particular power management systems 210. For example, the cobbler server 102 can be configured to utilize conventional or proprietary protocols or tools such as IPMI, DRAC, ILO, fence agents and the like. The power management module 230 can be configured to utilize a pre-determined protocol or utilize several protocols in order to determine the appropriate protocol. Once generated, the cobbler server 102 can be configured to transmit the instruction to the determined power management systems 210.

In embodiments, the power management module 230 can be implemented as a portion of the code for the cobbler server 102. Likewise, the power management module 230 can be implemented as a separate software tool accessible by the cobbler server 102. Additionally, the power management module 230 can be implemented as a portion of the code for the network management server 215. The power management module 230 can be written in a variety of programming languages, such as JAVA, C++, Python code, and the like to accommodate a variety of operating systems, machine architectures, etc. Additionally, the power management module 230 can be configured to include the appropriate application programming interfaces (APIs) to communicate with and cooperate with other components of the cobbler server 102.

In embodiments, once the storage device tool 212 has been initiated, the cobbler server 102 can be configured to interact with the storage device tool 212, directly, to instruct the storage device tool 212. Likewise, the cobbler server 102 can be configured to operate in conjunction with the network management server 215 in order to instruct the storage device tool 212. Whether directly or via the network management server 215, the cobbler server 102 can be configured to instruct the storage device tool 212 to perform management functions of one or more of the storage devices 206 and 208, such as adding, configuring, or reconfiguring the storage devices 206 and 208.

In embodiments, for example, the cobbler server 102, directly or via the management server 215, can transmit a common command and/or instruction to the storage device tool 212 to partition a particular storage device 206 on a particular target machine 205. Once received, the storage device tool 212, utilizing the translation library 213, can convert the common command and/or instruction into the specific command associated with the particular type of the storage device 206. Then, the storage device tool 212 can communicate the specific command and/or instruction to the particular storage device 206 in order to partition the storage device according to the command and or instruction.

In embodiments, the cobbler server 102 can be configured to instruct the storage device tool directly or configured to instruct the network management server 215 to interact with the storage device tool 212 in order to collect the storage device configuration data 214. The storage device tool 212 can also be configured to collect the storage device configuration data 214, automatically, in order to identify the type of the storage device. Once collected, the cobbler server 102 can be configured to receive the storage device configuration data 214 from the network management server 215 or directly from the storage device tool 212.

In embodiments, when collecting the storage device configuration data, the storage device tool 212 can be configured to utilize the translation library 213 in order to communicate with the storage device and to provide the storage device configuration data 214 in a common format. For example, once the storage device tool 212 acquires the storage device configuration data from a particular storage device, the storage device tool 212 can apply the appropriate conversion for the particular storage device, from the translation library 213, in order to produce the storage device configuration data 214 in the common format.

In embodiments, once data is received, the cobbler server 102 can be configured to store the configuration data 214 in storage device records 225. The storage device records 225 can include a number of individual storage device records 235. Each storage device record 235 can be configured to categorize the storage device configuration data 214 for the storage devices of a particular target machine 205. Each storage device record 235 in the storage device records 225 can be identified by information that uniquely identifies the target machines 205 in the network 115 such as Media Access Control (“MAC”) address, Ethernet Hardware Address (“EHA”), and the like. Each storage device record 235 can be configured to associate the storage device configuration data 214 of a particular storage device with the data that uniquely identifies the storage devices 206 or 208. The storage device configuration data can include, for example, the type of the storage device and the configuration of the storage device. The cobbler server 102 can be configured to maintain the storage device record 235 in the provisioning database 120, or any other local or remote storage system.

In embodiments, when utilizing the storage device configuration data 214 in the storage device records 225, the cobbler server 102 can be configured to perform other storage device management processes on the target machines 205. For example, the cobbler server 102 can be configured to utilize the storage device configuration data 214 in a particular storage device record 235 to check and to repair one or more storage devices 206 and 208 of the target machines 205 in the event of error or failure.

For instance, in one example, a particular target machine 205 can experience an error or other event such as an intruder attack. The cobbler server 102 can be configured to provide the storage device tool 212 to the particular target machine 205 and configured to instruct the storage device tool 212 to collect the current storage device configuration data, as described above. If the current storage device configuration data does not match the storage device configuration data 214 stored in the particular storage device record 235 for the target machine 205, the cobbler server 102 can be configured to instruct the storage device tool 212 to reconfigure the storage devices 206 or 208 according to the storage device configuration data 214 stored in the particular storage device record 235. The storage device tool 212 can be configured to convert the storage device configuration data 214, which is stored in the common format, into the specific format that corresponds to the storage device by utilizing the translation library 213. Likewise, the storage device tool 212 can be configured to utilize the translation library 213 to communicate with the storage device.

In embodiments as described above, the storage device records 225 can be generated and populated by the storage device configuration data 214 received from the storage device tool 212. Likewise, the storage device records 225 can be generated and populated independently of the storage device tool 212. For example, an administrator or operator of the network 115 can generate the records. Whether generated independently or by data from the storage device tool 212, the cobbler server 102 can be configured to provide the identification and the type of the storage devices 206 and 208 to the storage device tool 212 during the management processes to facilitate identifying the storage devices 206 and 208. Likewise, the firmware tool 212 can be configured to identify the type of the storage devices 206 and 208, independently, once initiated on the target machine 205.

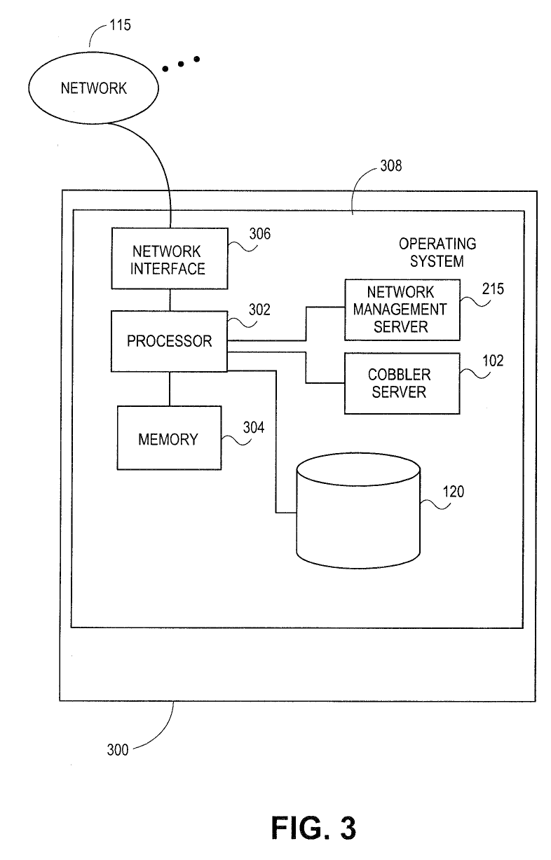

FIG. 3 illustrates an exemplary diagram of hardware and other resources that can be incorporated in a computing system 300 configured to communicate with the network 115, and execute the cobbler server 102 and the network management server 215 according to embodiments. In embodiments as shown, the computing system 300 can comprise a processor 302 communicating with memory 304, such as electronic random access memory, operating under control of or in conjunction with operating system 308. Operating system 308 can be, for example, a distribution of the Linux™ operating system, the Unix™ operating system, or other open-source or proprietary operating system or platform. Processor 302 also communicates with the provisioning database 120, such as a database stored on a local hard drive. While illustrated as a local database in computing system 300, the provisioning database 120 can be separate from the computing system 300 and the cobbler server 102 can be configured to communicate with the remote provisioning database 120.

Processor 302 further communicates with network interface 306, such as an Ethernet or wireless data connection, which in turn communicates with one or more networks 115, such as the Internet or other public or private networks. Processor 302 also communicates with the provisioning database 120, the cobbler server 102, and the network management server 215, to execute control logic and perform the storage device management processes described above and below.

As illustrated, the cobbler server 102 can be implemented as a software application or program capable of being executed by a conventional computer platform. Likewise, the cobbler server 102 can also be implemented as a software module or program module capable of being incorporated in other software applications and programs. In either case, the cobbler server 102 can be implemented in any type of conventional proprietary or open-source computer language.

As illustrated, the network management server 215 can be executed in the computing system 300. Likewise, the network management server 215 can be executed in a separate computing system including components similar to computing system 300. Accordingly, the computing system 300 can communicate with the network management server 215 via the network interface 306.

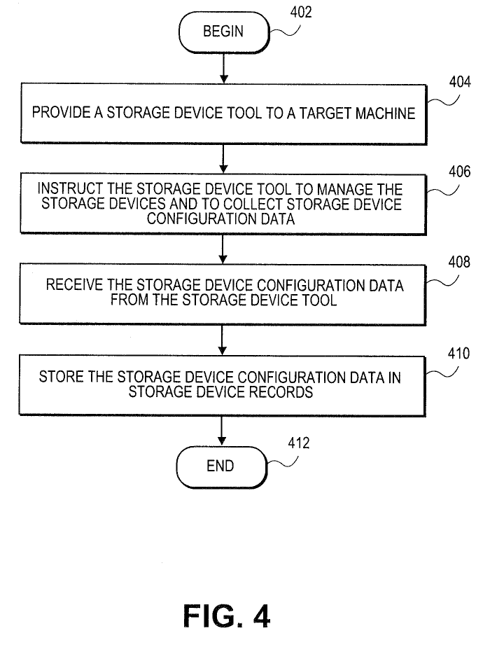

FIG. 4 illustrates a flow diagram for storage device management in the provisioning environment 200, according to embodiments of the present teachings. In 402, the process can begin. In 404, the cobbler server 102 can provide a storage device tool 212 to a target machine 205. For example, the cobbler server 102 can provide the storage device tool 212 when a target machine 205 is added to the network 115 or new storage devices 206 or 208 are added to a target machine 205. Likewise, the cobbler server 102 can provide the storage device tool 212 to the target machines 205 to configure or re-configure the storage devices 206 and 208 of the target machines 205. Additionally, the cobbler server 102 can provide the storage device tool 212 in the event an error occurs on the storage devices 206 or 208 or the target machines 205 (hardware/software failure, intruder attack on the target machines 205, etc.).

In 406, the cobbler server 102 can instruct the storage device tool 212 to manage the storage devices 206 and/or 208 and to collect storage device configuration data. For example, the cobbler server 102 can interact with the storage device tool 212, directly, to instruct the storage device tool 212. Likewise, the cobbler server 102 can operate in conjunction with the network management server 215 in order to instruct the storage device tool 212. Whether directly or via the network management server 215, the cobbler server 102 can instruct the storage device tool 212 to perform management functions of one or more of the storage devices 206 and/or 208, such as adding, configuring, or reconfiguring the storage devices 206 and/or 208.

The storage device tool 212 can utilize the translation library 213 to allow the cobbler server 102 to communicate with the storage devices 206 and/or 208 using common commands and/or instructions and to provide the configuration data 214 in a common format.

In 408, the cobbler server 102 can receive the storage device configuration data 214 from the storage device tool 212, if collected. For example, the cobbler server 102 can be configured to receive the storage device configuration data 214 directly or from the network management server 215.

In 410, the cobbler server 102 can store the configuration data 214 in storage device records 225. For example, the storage device records 225 can include a number of individual storage device records 235. Each storage device record 235 can categorize the storage device configuration data 214 for the storage devices of a particular target machine 205. Each storage device record 235 in the storage device records 225 can be identified by information that uniquely identifies the target machines 205 in the network 115 such as Media Access Control (“MAC”) address, Ethernet Hardware Address (“EHA”), and the like. Each storage device record 235 can associate the storage device configuration data 214 of a particular storage device with the data that uniquely identifies the storage devices 206 or 208. The storage device configuration data can include, for example, the type of the storage device and the configuration of the storage device.

In 412, the process can end, but the process can return to any point and repeat.

While the invention has been described with reference to the exemplary embodiments thereof those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of managing a software provisioning environment, comprising:
providing, from a provisioning server, a storage device tool to at least one target machine in a network of target machines, the at least one target machine including at least one storage device, wherein the storage device tool is configured to communicate with the at least one storage device independent of a type of the at least one storage device; and
providing, to the storage device tool, at least one command or instruction to manage the at least one storage device, wherein the storage device tool is configured to translate the at least one command or instruction into a specific command or instruction associated with the type of the at least one storage device.

2. The method of claim 1, the method further comprising:
receiving, from the storage device tool, configuration data for the at least one storage device; and
storing the received configuration data in a storage device record.

3. The method of claim 2, the method further comprising:
comparing the received configuration data with previously stored configuration data in the storage device record; and
providing the previously stored configuration data to the storage device tool if the received configuration data differs from the previously stored data, wherein the storage device tool is configured to apply the previously stored configuration data to the at least one storage device.

4. The method of claim 2, wherein receiving the configuration data comprises:
instructing a network management server to collect the configuration data from the storage device tool; and
receiving the configuration data from the network management server.

5. The method of claim 1, wherein the storage device tool is a disk image containing the storage device tool.

6. The method of claim 1, wherein providing the storage device tool comprises:
instructing a helper client on the at least one target machine to retrieve the storage device tool.

7. The method of claim 1, wherein providing the storage device tool comprises:
transmitting the storage device tool to the at least one target machine over the network; and
sending instructions to alter a power state of the at least one target machine after transmitting the storage device tool.

8. A system for managing a software provisioning environment, comprising:
a network interface to a network of target machines; and
a provisioning server, communicating with the network interface and a network management server, the provisioning server being configured to
provide a storage device tool to at least one target machine in the network of target machines, the at least one target machine including at least one storage device, wherein the storage device tool is configured to communicate with the at least one storage device independent of a type of the at least one storage device; and
provide, to the storage device tool, at least one command or instruction to manage the at least one storage device, wherein the storage device tool is configured to translate the at least one command or instruction into a specific command or instruction associated with the type of the at least one storage device.

9. The system of claim 8, the provisioning server being further configured to
receive, from the storage device tool, configuration data for the at least one storage device; and
store the received configuration data in a storage device record.

10. The system of claim 9, the provisioning server being further configured to
compare the received configuration data with previously stored configuration data in the storage device record; and
provide the previously stored configuration data to the storage device tool if the received configuration data differs from the previously stored data, wherein the storage device tool is configured to apply the previously stored configuration data to the at least one storage device.

11. The system of claim 9, wherein receiving the configuration data comprises:
instructing the network management server to collect the configuration data from the storage device tool; and
receiving the configuration data from the network management server.

12. The system of claim 8, wherein the storage device tool is a disk image containing the storage device tool.

13. The system of claim 8, wherein providing the storage device tool comprises:
instructing a helper client on the at least one target machine to retrieve the storage device tool.

14. The system of claim 8, wherein providing the storage device tool comprises:
transmitting the storage device tool to the at least one target machine over the network; and
sending instructions to alter a power state of the at least one target machine after transmitting the storage device tool.

15. A provisioning application, the provisioning application being embodied in a computer readable storage medium and comprising instructions for causing a processor to perform a method comprising:
providing a storage device tool to at least one target machine in a network of target machines, the at least one target machine including at least one storage device, wherein the storage device tool is configured to communicate with the at least one storage device independent of a type of the at least one storage device; and
providing, to the storage device tool, at least one command or instruction to manage the at least one storage device, wherein the storage device tool is configured to translate the at least one command or instruction into a specific command or instruction associated with the type of the at least one storage device.

16. The provisioning application of claim 15, the method further comprising:
receiving, from the storage device tool, configuration data for the at least one storage device; and
storing the received configuration data in a storage device record.

17. The provisioning application of claim 16, the method further comprising:
comparing the received configuration data with previously stored configuration data in the storage device record; and
providing the previously stored configuration data to the storage device tool if the received configuration data differs from the previously stored data, wherein the storage device tool is configured to apply the previously stored configuration data to the at least one storage device.

18. The provisioning application of claim 16, wherein receiving the configuration data comprises:
instructing a network management server to collect the configuration data from the storage device tool; and
receiving the configuration data from the network management server.

19. The provisioning application of claim 15, wherein the storage device tool is a disk image containing the storage device tool.

20. The provisioning application of claim 15, wherein providing the storage device tool comprises:
instructing a helper client on the at least one target machine to retrieve the storage device tool.

21. The provisioning application of claim 15, wherein providing the storage device tool comprises:
transmitting the storage device tool to the at least one target machine over the network; and
sending instructions to alter a power state of the at least one target machine after transmitting the storage device tool.

22. A storage device tool, the storage device tool being embodied in a computer readable storage medium and comprising instructions for causing a processor to perform a method comprising:
receiving a command or instruction to manage at least one storage device;
translating the command or instruction into a specific command or instruction associated with a type of the at least one storage device; and
providing the specific command or instruction to the at least one storage device.

23. The storage device tool of claim 22, the method further comprising:
determining the type of the at least one storage device; and
retrieving, from a translation library, the specific command or instruction based on the determined at least one type of the at least one storage device.
